(19) United States
(12) Patent Application Publication
(10) Pub. No.: US 2006/0040035 A1
(43) Pub. Date: Feb. 23, 2006

(54) Bakeable icing

(76) Inventor: Leann M. Thompson, New Milford, CT (US)

Correspondence Address: WINSTON & STRAWN LLP, 1700 K STREET, N.W., WASHINGTON, DC, 20006, US

(21) Appl. No.: 10/922,702

(22) Filed: Aug. 19, 2004

(51) Int. Cl. A23L 1/09

(52) U.S. Cl. 426/572

(57) ABSTRACT

The invention is directed to a bakeable icing for use with a ready-to-use dough. The icing is prepared from functional whey protein, and sweetener and spreads across the dough upon heating or baking. The icing is applied to a dough that may be provided in a form that includes grooves, score lines, or a combination thereof, to facilitate separation of the dough into pieces that can be baked into individual iced or frosted bakery products such as cookies, muffins, brownies, or other pastries.

### FIELD OF INVENTION

The present invention relates to a bakeable icing composition that is capable of icing a bakery dough product or an already prepared foodstuff during heating or baking. In particular, the invention relates to a self-icing cookie dough that ices itself during baking to provide an indulgent, frosted or filled cookie treat.

### BACKGROUND ART

A variety of ready-made icings and iced food products already exists on the market. For example, prepared icings packaged in resealable containers are available in the baking section of any grocery store. Typically, consumers purchase these packaged icings to frost homemade baked goods, such as cakes and cupcakes. Although the ready-made icing is very convenient for application to home baked goods, the icing must be applied to the goods after they have been baked and allowed to cool. If the icing is applied onto the cake or cupcake while still hot, the icing tends to become too fluidized and then becomes too difficult to spread on the baked good and melts off the baked good. Generally, conventionally prepared icings consist of sugar, water, and flavoring.

In addition to the ready-made icings, there currently exists frozen food products that are sold with a prepackaged icing to be applied to the frozen food after it is cooked. The instructions for use of such icings require that the frozen food be cooked then the icing may be applied. For example, strudel are typically placed in the toaster and after sufficient heating, the pastry is removed from the toaster and the icing is drizzled on the hot pastry to provide a frosted treat.

U.S. Patent Application 2002/0142070 to Bedi et al. discloses a topping composition that is applied to a food product after the food is thawed, and warmed.

U.S. Pat. No. 6,368,645 to Huang discloses an iced food product, such as a cake or waffle, that is heated at a temperature from about 250° to about 350° F. for about 5 to 40 minutes. The icing applied to the food product does not substantially change appearance during the heating process.

Consumers are always in need of simple and convenient methods of preparing indulgent, tasty foods. Although ready-made icings and iced food products are currently available, the conventional icings and iced food products have to be applied to already baked foods and in addition, the time for cooling has to pass in order to achieve a suitable iced food item. Therefore, there is a need for a simple, and convenient icing that is capable of icing a food item during baking. The present invention satisfies this need by providing a bakeable icing.

### SUMMARY OF INVENTION

The present invention relates to a consumer-friendly, ready-to-use bakeable icing, which requires only to be applied to a foodstuff and is capable of self-icing the foostuff to provide, a tasty, iced bakery product. The foodstuff can be a ready-to-use bakery dough, or a prepared foodstuff. The bakeable icing can be applied to a surface of the foodstuff or bakery dough in any desirable pattern such as a dollop, swirls, or drizzles. Advantageously, the bakeable icing has a pliable consistency that assists in the application of various desired patterns of icing on the foodstuff or bakery dough. The bakeable icing is heat tolerant and is capable of being baked in the oven with the bakery dough or the foodstuff. During heating, the bakeable icing spreads across the surface to which it is applied on the bakery dough or other foodstuff and self-ices the baked product. After the bakeable icing spreads on the foodstuff or bakery dough, the icing sets to form a thick icing which has a fudge-like consistency. Thus, the bakeable icing of the invention allows for a scrumptious, iced or filled treat with very little effort on the part of the baker or consumer.

In one aspect of the invention the bakeable icing comprises a functional whey protein and a sweetener. The functional whey protein is present in an amount between about 8 to 16% of the composition. The whey protein is preferably a mildly, flavored functional whey protein. A suitable functional whey protein is Grande Bravo 300®. However, other functional whey proteins may be used.

The sweetener may be sugar, corn syrup or a combination thereof, present in an amount between about 1% to 50% by weight of the bakeable icing. For example, suitable sugars include sucrose and high fructose corn syrup. However, as will be appreciated in the art other known sweeteners may be used as discussed below.

The bakeable icing composition preferably further includes at least one of fat, milk, water, flavorant, emulsifier, salt, or a combination thereof. A suitable fat is butter, edible oil, cocoa butter, margarine, shortening, peanut butter, or other nut butters such as hazelnut, almond, and the like, or tropical oils such as but not limited to cocoanut and palm kernel oil. The fat is present in an amount between about 0% to 15% by weight of the icing.

The milk may be sweetened condensed milk, condensed milk, whole milk, skim milk, or low fat milk present in an amount between about 10% to 45% of the icing. Preferably, the milk is sweetened condensed milk. The milk may be a liquid concentrated form or in a dried form.

The flavorant is preferably present in an amount of between about 1% to about 50% and may be chocolate, peanut butter, or caramel. However, as will be appreciated by one skilled in the art, the flavorant depends on the desired flavor for the icing, and is not limited to chocolate, peanut butter or caramel flavorings. Suitable flavorants include chocolate chips, chocolate chunks, peanut butter chips, peanut butter paste, or a combination thereof. The chocolate may be any variety for example, milk chocolate, dark chocolate, white chocolate, semi-sweet chocolate, unsweetened chocolate or a combination thereof.

The icing optionally comprises an emulsifier and salt. A suitable emulsifier is Tandem 5K®. Although other known emulsifiers may be used. The emulsifier may be present in an amount between about 0% to about 1.5% of the icing composition. The salt, for example, sodium chloride, may be present in an amount between about 0% to about 1% of the icing composition.

In one preferred embodiment, a bakeable icing is provided comprising functional whey protein present in an amount of between about 10% to 12% of the weight of the icing, sugar present in an amount between about 6% to about 8%, milk present in an amount of about 30% to 35%, water present in an amount between about 0% to 25%, flavorant present in an amount between about 35% to 40% of the weight of the composition, and an emulsifier. Preferably, the flavorant includes chocolate or peanut butter.

In another preferred embodiment, the bakeable icing is a caramel icing comprising functional whey protein present in an amount between about 10% to 12% of the icing, fat present in an amount between about 8% to 12%, sucrose present in an amount between about 8% to 12%, corn syrup present in an amount between about 25% to 45%, and milk present in an amount between about 10% to 25% of the icing.

Any of the embodiments of the bakeable icing provides a consumer with a convenient and user friendly way to transform a cookie or other baked good into a scrumptious, iced treat without having to first bake the good and then wait for it to cool before icing the item. Now, the consumer can apply the bakeable icing of the invention to the item to be iced prior to baking or heating the item. Then after applying the icing to the item, both the item and the bakeable icing are baked or heated together. During baking or heating, the bakeable icing spreads across the item and forms a tasty, icing having a fudge-like consistency.

Moreover, the bakeable icing may optionally include edible inclusions such as pecans, macadamia nuts, cookie pieces, non-pariels, sprinkles, fruits, candies, or a combination thereof. Other edible inclusions may be added as desired.

In another aspect of the invention is provided a self-icing bakery dough comprising a ready-to-use bakery dough and the bakeable icing. “Ready-to-use bakery dough” means any prepared bakery dough ready to heat, re-heat, or bake to provide a baked good such as a refrigerated or frozen cookie dough, brownie dough, muffin dough, croissant dough, donut dough, donut stick dough, waffle dough, pancake dough, pastry dough, or filled pocket dough, or already cooked refrigerated or frozen bakery goods such as strudel, turnovers, cupcakes, and the like. Thus, the consumer only has to bake or heat the self-icing bakery dough to obtain an iced treat.

The icing may be applied to the top surface of the bakery dough so that an iced or frosted baked good is provided upon heating, baking or even reheating of the good. If a filled baked treat is desired, however, the icing may be applied inside the bakery dough to provide a filled baked good, such as a filled hot pocket or cookie for example. In another variety, the icing can be applied to more than one surface of the bakery dough for example to provide an iced, and filled treat. Advantageously, the self icing bakery dough provides a frosted or iced bakery product just by heating or baking the self icing bakery dough. During heating or baking of the self icing bakery dough, the bakeable icing undergoes a physical change from its pliable consistency and becomes fluidized such that the icing spreads across the surface of the bakery dough. After the fluidized icing sets the consistency becomes a fudge-like consistency to and provides a baked good having a thick icing. The term “baked good” means any good whether it is baked, heated, or reheated to which the bakeable icing is applied.

Advantageously, the icing coats the bakery dough to provide a filled baked good or a frosted baked dough, but does not become so fluidized that it runs off the surfaces of the bakery dough during baking or heating.

In one embodiment, a self-icing cookie dough is provided. Thus, a unique, user-friendly, one-step, refrigerator to oven, iced cookie is provided. The cookie dough may be a frozen, or refrigerated cookie dough which is ready to bake. The bakeable icing is applied to a surface of the cookie dough to provide a self-icing cookie. Preferably, the cookie dough is in the form of a sheet or block having grooves, score lines, or combinations thereof defining pieces of self-icing dough to be broken off and baked.

### DETAILED DESCRIPTION OF THE INVENTION

It has been discovered that it is possible to have a ready-made icing of the type that can be baked, heated or reheated with a foodstuff or bakery dough to which the bakeable icing is applied. The bakeable icing ices the foodstuff or bakery dough during baking, heating, or reheating of the foodstuff or bakery dough. For example, the bakery dough can be ready-to-bake dough for cookie, muffins, turnovers, brownies, or other pastry. For further example, the cookie dough may be the refrigerated or frozen type, such as Nestle TOLL HOUSE® cookie dough or any other variety. Alternatively, the foodstuff may be an already prepared foodstuff such as a strudel, donut, waffle, pancake, and the like. Prior to baking or reheating, the bakeable icing is applied to a surface of the bakery dough or the foodstuff. In this regard, the icing ices the good as heats, or bakes.

The bakeable icing may be applied to the foodstuff in any pattern, such as a dollop, swirls, drizzles, by a spoon, knife, or pastry bag. The bakeable icing may be applied to any surface of the foodstuff. For example, the bakeable icing may be applied to the top surface of the foodstuff or bakery dough to provide an iced baked good, or an inner surface of the foodstuff or bakery dough to provide a filled baked good. Alternatively, the icing may be applied to more than one surface of the foodstuff or bakery dough to provide for example, an iced, filled baked good.

One advantage of the bakeable icing is that the icing is not required to be applied to the baked good after the good is baked or heated, and then cooled. As known by consumers, typical icings are applied to baked goods after the goods have been baked and after they have cooled. If the icing is applied to the baked good prior to sufficient cooling, it is very difficult to ice the baked good and often times, the cake, muffin, or good splits or the icing becomes too fluid and run off occurs.

The bakeable icing overcomes the difficulties of conventional icings and is baked or heated together with the foodstuff or bakery dough. Further, the icing self-ices the good during the heating or baking step. Thus, preparation of an iced bakery product no longer requires three steps. That is, first bake the food item, second, allow the food to cool, and third, ice the foodstuff. The bakeable icing of the invention allows the baking or heating or reheating of an iced bakery product by just applying the bakeable icing to a surface of the good to be iced, and bake, heat or reheat.

The invention includes a number of different embodiments, one of which is exemplified by a bakeable icing composition comprising functional whey protein and a sweetener. The functional whey protein is present in an amount between about 8% to 16% of the icing composition, preferably about 10% to 13% of the icing. The term “bakeable icing” is used to mean ready-made icing composition of the types used for frosting or icing bakery items that can withstand baking or heating temperatures. The whey protein is preferably a mildly flavored functional whey protein. An example of a suitable functional whey protein is Grande BRAVO 300®. However, alterative functional whey proteins may be used.

The sweetener may be a sugar such as sucrose or corn syrup or a combination thereof. The sugar that is used can be of any type. Sugars include, but are not limited to, fructose, sucrose, dextrose, corn syrup e.g., high fructose corn syrup, glucose, lactose, galactose, maltose, invert sugar, or mixtures thereof. Preferably, high fructose corn syrup or sucrose is used. Alternatively, a sugar substitute such as sorbitol, saccharine or any other known sugar substitute can be added either in conjunction with sugar or as a substitute for the sugar. Other sugar substitutes or artificial, i.e., non-nutritive sweeteners can be used when low calorie baking products are desired to be made.

The sweetener can be present in an amount from about 1% to about 50%, and preferably in an amount from about 3% to about 45%, most preferably, between 5% to about 42% of the composition.

The bakeable icing preferably further comprises at least one of milk, fat, water, flavorant, milk, salt, and emulsifier.

The milk is present in an amount between about 10% to about 45% of the composition by weight, preferably in an amount between about 15% and 40%, and most preferably between 18% to about 33%. The milk may be condensed milk, sweetened condensed milk, regular milk, skim milk, and low fat milk. Preferably, sweetened condensed milk is used.

The fat is preferably in an amount between about 0% to about 15%, preferably, between about 6% to about 12%. The fat may be butter, margarine, or edible oils. Preferably, butter is used.

The flavorant is present in an amount between about 1% to about 50% by weight of the icing composition. The choice of flavorant depends on the flavor desired for the bakeable icing. Examples include for instance, chocolate, peanut butter, and caramel. To this end, flavorant for a chocolate icing includes sweetened chocolate, semi-sweet chocolate, milk chocolate, white chocolate, dark chocolate. Flavorant for a peanut butter icing includes peanut butter paste, or peanut butter chips, or a combination thereof. Flavorant for a caramel flavored icing includes high fructose corn syrup. In addition, artificial flavorings may be used or added to the icing composition.

The water is present in an amount between about 0 to about 25% by weight of the composition. Water can be any type such as purified water, other otherwise. The salt may be present in an amount from about 0% to about 1% of the icing composition, and the emulsifier may be present in an amount between about 0% to about 1.5% of the composition.

Optionally, the icing may contain edible inclusions. Edible inclusions include, but are not limited to, chocolate pieces, oat flake pieces, raisins, fruit pieces, whole nuts or nut pieces, i.e., groundnuts, hazelnuts or other nuts, caramel, or various mixtures thereof. The inclusions can be of any edible size, and are typically from about 1 mm to about 25 mm, preferably from about 4 mm to about 10 mm. The amount of inclusions is not critical and can vary from 1 to 30% by weight. Optionally, dark chocolate, milk chocolate, white chocolate, compound coatings or mixtures thereof may be used in the form of morsels, pellets or chunks. Typically, chocolate is present in an amount from about 5% to about 50%, and preferably in an amount from about 10% to about 30% by weight. The chocolate can be a commercial chocolate or a chocolate of the type used in pastry making or in catering.

In a preferred embodiment, a chocolate icing comprises functional whey protein present in an amount between about 8-12%, sucrose present in an amount between about 5 to 10%, water in an amount between about 10-25%, chocolate in an amount between about 30-40%, sweetened condensed milk in an amount between about 25 to about 35% and an emulsifier.

In another preferred embodiment, a peanut butter icing comprises functional whey protein present in an amount between about 8% to 12% of the icing, high fructose corn syrup present in an amount between about 5% to 10% of the icing, water in an amount between about 10% to about 25% of the icing, peanut butter chips present in an amount between about 25% to about 40% of the icing, peanut butter paste present in an amount between about 1% to about 5% of the icing, salt present in an amount between about 0.01% to about 1%, sweetened condensed milk present in an amount between about 25% to about 35% and emulsifier.

In yet another preferred embodiment, a caramel icing comprises functional whey protein in an amount between about 8% to 12%, sucrose present in an amount between about 8 to 15%, water present in an amount between about 10% to about 20%, high fructose corn syrup present in an amount between about 25% to about 40%, butter present in an amount between about 5% to about 15%, and sweetened condensed milk present in an amount between about 15% and 25%.

Preferably, the functional whey protein is combined with the water under high speed agitation. Thereafter, the remaining ingredients of the respective icings are added to the agitated mixture. The mixture is then heated slowly from about 5 to 20 minutes.

In another aspect of the invention is provided a self-icing bakery dough comprising a ready to use bakery dough and a bakeable icing. The term “self-icing” as used herein means that the bakery product ices itself during baking, heating or reheating.

Generally, the dough is prepared from flour, sugar, a leavening agent, and fat as disclosed in U.S. Pat. Nos. 6,024,997, 6,280,783, 6,284,295 and 6,312,743, each of which are incorporated herein by reference. The dough according to the invention can have several shapes. Preferably, the dough is shaped into a block or sheet. The block may be either of parallelepipedal shaped, cylindrical shape or prismatic shape. In a preferred embodiment, the ready-to-use bakery dough is a refrigerated or frozen cookie dough.

The bakery dough has bakeable icing applied to at least one of its surfaces. For example, the top surface or an inner surface. Subsequently, the baker dough having bakeable icing is placed on a baking tray and baked. During baking, the dough flows into a substantially circular shape and the bakeable icing fluidizes and spreads across the surface of the dough and self-ices the bakery dough. As the icing has a pliable consistency at room temperature it may be applied to the bakery dough in any desired pattern including a dollop, swirl, or drizzle. The pliable icing becomes fluidized during baking, or heating the ready-to-use bakery dough and spreads across the bakery dough as it bakes and self ices the dough. In some embodiments, the consistency and texture of the icing, for example, chocolate or peanut butter icing, changes to form an icing having a thick, fudge-like consistency and texture. The term “fudge-like” as used herein describes the consistency and texture of the icing and is not meant to denote a chocolate or a fudge taste. In another embodiment, the icing has a caramel-like consistency. As an example, the caramel icing of the invention may have a caramel-like consistency. Thus, any embodiment of the present invention provides an indulgent, iced or filled treat.

In one embodiment, the dough block has an imprint to facilitate breaking the dough into smaller blocks, pieces or portions. The imprint or precut facilitates breaking the bakery dough prior to baking. The block of dough with an imprint can be broken into smaller blocks by using a knife or by hand. When using a knife, the knife completely cuts the block of dough beyond the imprint. Alternatively, the block of dough can be pulled apart using one's hands. As long as the block of dough has an imprint or a partial cut, the dough blocks can be either cut or broken into smaller size pieces of rectangular, circular, triangular or any other geometric shapes. There is no waste due to shaping and no manipulation, other than cutting or breaking of the dough by the consumer, prior to baking. In addition, the bakeable icing is applied to the block of bakery dough such that each defined piece of dough has sufficient bakeable icing to provide an iced or filled treat upon baking or heating.

The bakery dough according to the invention may also contain natural or artificial flavoring agents which complements or enhance the flavor of the bakeable icing. The natural or artificial flavoring agents used in the dough may include but are not limited to, vanilla flavor, cinnamon, ginger, cocoa powder, fruit flavor, nut flavor (e.g., peanut butter or peanut flour), and the like. These are typically used in an amount of about 0.01% to about 8% by weight, and preferably from 0.25 to 7% by weight of the dough. Of course, various combinations of these flavoring agents are possible, as desired.

According to the invention, the block or sheet of dough is sufficiently thick to form a cookie or other bakery product of edible size upon baking. Typically, the bakery dough sheet has a thickness of from about 0.5 cm to about 5 cm, and preferably from about 1 cm to about 3 cm.

The groove or score line depth should be sufficient to allow the consumer to either break the blocks, as is known with typical chocolate bars, or to pull the blocks apart. A knife can be used to cut along the grooves or score lines, although this is not necessary. For a dough thickness of 3 cm, the depth of the grooves or score lines would typically be from about 1 mm to about 20 mm, and preferably from about 5 mm to about 15 mm. When grooves are present, a width of from about 1 mm to about 10 mm, preferably from about 3 mm to about 7 mm is used. When using a combination of grooves and score lines, the groove typically has a depth of from about 7 mm to about 12.5 mm and the depth of the score line is from about 12.5 mm to about 8 mm. Preferably, the groove is from about 5 mm to about 10 mm wide, and the score line is from about 1 mm to about 3 mm wide. In a preferred combination for a 3 cm thick dough block, the width of the groove is about 8 mm, the width of the score line is from about 2 mm, the depth of the groove is from about 10 mm and the depth of the score line is about 10 mm. Preferably, the grooves, score lines, or combinations do not cut through the entire thickness of the dough.

According to one embodiment of the invention, the block has at least two different layers and the icing is provided between the two different layers. The number of layers is not critical, but from a practical point of view, the number of layers is typically between 2 and 6. Preferably, the number of layer is 2. However, where more than two layer is used, the bakeable icing may be applied between each of the layers of dough to provide an iced layered treat. The bakeable icing applied between the layers of dough may each have the same flavor or may be different. The different layers of dough may also be different. This can be done for example by adding to the basic dough different types of flavors or colors, which are accepted in the food area. For example, it is possible to have the basic dough as first layer and dough added with cocoa as the second layer, wherein the resultant cookie has both a clear face and a dark face and a bakeable icing filling between the two faces of the cookie. For example, the bakeable icing filling may be a chocolate icing to enhance the cocoa flavor of the second layer or may be a caramel or peanut butter flavor to complement the cocoa flavor.

In another embodiment, a ready-to-bake self-icing cookie dough is provided. The cookie dough comprises refrigerated or frozen cookie dough, and bakeable icing. The cookie dough is preferably in the form of a sheet or block and preferably has an imprint of grooves, score lines, or a combination thereof such that defined pieces of dough are provided to be broken off and baked. The bakeable icing is applied to a surface of the cookie dough. During baking of the self-icing cookie dough, the dough forms a generally circular iced cookie. The icing spreads across the cookie surface during baking of the cookie dough. The bakeable icing may be applied to the top surface of the cookie or applied to an inner surface of the cookie dough. Thus, a sandwich type cookie may be provided or a traditional top iced cookie may be provided. The cookie dough may be any variety, chocolate chip, sugar cookie, oatmeal raisin or any other type. The icing may be for example, chocolate, peanut butter, or caramel. The cookie may further include edible inclusions such as nuts, sprinkles or chocolate chunks, raisins, or other edible inclusions.

### EXAMPLES

Exemplary formulations that can be used to prepare an icing or filling meeting one or more of the objectives described herein, are summarized as follows:

The various ingredients stated in the table below are mixed. The proportions are in percentages by weight.

### Examples 1

### Chocolate Icing

| Components | Weight Percent |
|---|---|
| Functional whey protein | 11.92% |
| Sugar | 7.2% |
| Water | 12.4% |
| Semi-Sweet Chocolate | 36.7% |
| Sweetened Condensed Milk | 31.7% |
| Emulsifier | 0.08% |

### Example 2

### Peanut Butter Icing

| Components | Weight Percent |
|---|---|
| Functional whey protein | 11.3% |
| High fructose corn syrup | 7.2% |
| Water | 13.02% |
| Peanut butter chips | 34.6% |
| Peanut butter paste | 1.5% |
| Salt | 0.06% |
| Sweetened condensed milk | 31.7% |
| Emulsifier | 0.08% |

The icing or filling of Example 1 and 2 can be prepared by combining the ingredients, as will be understood by one skilled in the art. However, preferably, the whey protein is combined with water under high speed agitation followed by combining the remaining ingredients to the whey protein water mixture. The mixture is then heated slowly to a temperature of about 140° to 180° F. for approximately about 5 to 10 minutes.

### Example 3

### Caramel Icing

| Components | Weight Percent |
|---|---|
| Functional whey protein | 11.5% |
| Sugar | 11.2% |
| Water | 15.2% |
| High fructose corn syrup | 31.5% |
| Butter | 10.6% |
| Sweetened condensed milk | 20% |

Preparation of the caramel icing of Example 3 preferably includes combining the whey protein to a water, then adding the remaining ingredients and heating the mixture to about 230° F. for approximately about 15-20 minutes.

The bakery dough can be prepared and stored for as long as 6 months in the refrigerator or up to one year in a freezer. In one embodiment, the bakery dough is a brownie mix, and pieces of a size of about 3.5×3.5 cm are broken off the block and then are placed in a greased 20×20 cm pan for baking. The breaking of the dough into pieces enables the iced brownie mix to fill the pan properly to facilitate baking. The pieces are baked for about 25 minutes at 170° C. The pieces enable the oven heat to surround them, and the pieces flow into each other as they bake. Although the final baked product is a single mass, it is mole evenly cooked than brownie mixes that are not previously formed into a block and separated as described above. Alternatively, as mentioned above, the bakery dough may be a self-icing cookie dough, in which pieces are broken off from the block or sheet and placed in a greased cookie sheet for baking. The pieces are baked for about 13 to about 18 minutes at about 170° C.

The embodiments of the invention described above are intended to be merely exemplary, and those skilled in the art will recognize, or will be able to ascertain using no more than routine experimentation, numerous equivalents of the specific materials, procedures, and devices described herein.

What is claimed is:

1. A bakeable icing composition comprising a functional whey protein and a sweetener, wherein the functional whey protein is present in an amount between about 8% to about 16% of the icing composition.

2. The bakeable icing of claim 1, wherein the icing is applied to a surface of a frozen or refrigerated foodstuff prior to heating or baking the foodstuff.

3. The bakeable icing of claim 2, wherein the icing becomes fluidized during heating or baking and ices the foodstuff to which the icing is applied.

4. The bakeable icing of claim 2, wherein the surface is a top surface or inner surface of the foodstuff.

5. The bakeable icing of claim 1, wherein the icing has a pliable consistency at room temperature and is capable of being applied to a foodstuff in a desired pattern.

6. The bakeable icing of claim 5, wherein the bakeable icing is applied to the foodstuff in a dollop, swirl, drizzle, or a combination thereof.

7. The bakeable icing of claim 1, wherein the sweetener is a sugar or corn syrup.

8. The bakeable icing of claim 1, wherein the icing further comprises at least one of milk, fat, water, flavorant, emulsifier, salt, or any combination thereof.

9. The bakeable icing of claim 8, wherein when present, the milk is present in an amount between about 15 to about 45% of the icing composition, the fat is present in an amount between about 5 to about 25% by weight of the icing composition, the water is present in an amount between about 5% to about 25% by weight of the icing composition, the flavorant is present in an amount between about 1% to about 50% of the icing composition, the emulsifier is present in an amount between about 0.01 to about 1.5% by weight of the icing composition, and the salt is present in an amount between about 0.001 to about 0.09% by weight of the icing composition.

10. The bakeable icing of claim 9, wherein the icing is a chocolate icing, and further wherein the chocolate icing comprises a mildly flavored functional whey protein, sucrose, water, chocolate, sweetened condensed milk and an emulsifier.

11. The bakeable icing of claim 10, wherein the chocolate is milk chocolate, dark chocolate, white chocolate, semi-sweet chocolate, unsweetened chocolate or a combination thereof.

12. The bakeable icing of claim 9, wherein the icing is a peanut butter icing, and further wherein the peanut butter icing comprises a mildly flavored functional whey protein, corn syrup, water, peanut butter, salt, sweetened condensed milk, and an emulsifier.

13. The bakeable icing of claim 12, wherein the peanut butter is in the form of chips, paste, or both.

14. The bakeable icing of claim 12, wherein the corn syrup is high fructose corn syrup.

15. The bakeable icing of claim 9, wherein the icing is a caramel icing, and further wherein the icing comprises a mildly flavored whey protein, sugar, water, corn syrup, butter, and sweetened condensed milk.

16. The bakeable icing of claim 1, wherein the icing further includes edible inclusions selected from the group consisting of nuts, cookie, non-pariels, sprinkles, fruits, candies, chocolate solids, peanut butter solids, or any combination thereof.

17. The bakeable icing of claim 2, wherein the frozen or refrigerated foodstuff is a ready to use bakery dough, or an already prepared bakery good.

18. A self-icing bakery dough comprising:
a ready-to-use bakery dough, and
a bakeable icing applied to the bakery dough, wherein the icing is capable of coating the bakery dough during heating or baking of the foodstuff to provide a self-iced baked good.

19. The self icing bakery dough of claim 18, wherein dough is in a sheet or block form and has a thickness and a surface which includes grooves, score lines or combinations thereof defining pieces of dough to be broken off and baked.

20. The self icing bakery dough of claim 18, wherein the dough has at least two different dough layers, and further wherein the bakeable icing is applied between the two different dough layers.

21. The self icing bakery dough of claim 20, wherein the bakeable icing applied between the two different dough layers is enclosed by the dough layers to form a filled pocket.

22. The self-icing bakery dough of claim 18, wherein the bakeable icing is applied to the dough in a dollop, pattern, swirl, or drizzle.

23. The self-icing bakery dough of claim 18, wherein the bakeable icing coats the bakery dough during baking of the bakery dough and has a consistency such that the icing does not run off the sides of the baked good.

24. The self-icing bakery dough of claim 18, wherein the bakeable icing is applied to a top surface of the bakery dough to provide an iced baked good.

25. The self-icing bakery dough of claim 18, wherein the bakeable icing is applied to an inner surface of the bakery dough and provides filled baked good.

26. The bakeable icing of claim 18, wherein the self icing bakery dough is a ready to bake refrigerated or frozen dough.

27. The self icing bakery dough of claim 18, wherein the self iced baked good is a cookie, muffin, brownie, pastry, croissant, or filled dough pocket.

28. The self icing bakery dough of claim 18, wherein the bakeable icing comprises a functional whey protein and a sweetener.

29. The self icing bakery dough of claim 28, wherein the bakeable icing further comprises at least one of milk, fat, water, flavorant, emulsifier, salt, or a combination thereof.

30. The self-icing bakery dough of claim 1, wherein the icing is chocolate, peanut butter, or a caramel icing.

31. A self-icing cookie dough comprising
a refrigerated or frozen cookie dough, and
the bakeable icing of claim 1.

32. The self-icing cookie dough of claim 31, wherein the bakeable icing ices the cookie during baking of the cookie dough.

33. The self-icing cookie dough of claim 31, wherein the cookie dough is in the form of a sheet or block having grooves, score lines, or combinations thereof defining pieces of dough to be broken off and baked.

34. The self-icing cookie dough of claim 31, wherein the cookie dough further includes edible inclusions.

35. The self icing cookie dough of claim 34, wherein the edible inclusions include chocolate, nuts, raisins, or sprinkles.
